(19) United States
(12) Patent Application Publication
(10) Pub. No.: US 2008/0158522 A1
(43) Pub. Date: Jul. 3, 2008

(54) LASER PROJECTOR FOR CONTROLLING POWER TO DRIVE LASER DIODES AND METHOD THEREOF

(75) Inventor: Jeong-phil SEO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/772,848

(22) Filed: Jul. 3, 2007

(30) Foreign Application Priority Data
Dec. 27, 2006 (KR) 2006-135555

(51) Int. Cl. G03B 21/20

(52) U.S. Cl. 353/85

(57) ABSTRACT

A laser projector which controls power to a plurality of light sources and a method thereof are provided. The laser projector includes a plurality of light sources, a sensing unit, a power supply unit which supplies power to each of the light sources, and a control unit which adjusts the power supplied to the light sources, based on a sensing result of the sensing unit. Since the power supplied to the light sources is controlled based on the result of sensing at least one of a motion of an object and a slope of the projector, a user is protected from a laser beam emitted from the laser projector.

### CROSS-REFERENCE TO RELATED APPLICATIONS

This application claims priority under 35 U.S.C. § 119 from Korean Patent Application No. 10-2006-0135555, filed on Dec. 27, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to controlling power to drive light sources, and more particularly, to controlling power to drive each of a number of light sources according to a result of sensing all environments of a laser projector.

2. Description of the Related Art

A laser projector, a laser projection system, and the like, are display apparatuses which display an image by projecting an image onto screen, based on an input image signal, by using a laser beam emitted from a laser light source (for example, laser diode). These display apparatuses are often used to realize presentations in a conference room, film projectors in theaters, home theaters, and the like.

When power is supplied to a laser diode included in a laser projector, the laser diode emits a laser beam. When the laser beam is emitted to the outside, a user may be exposed to the laser beam. When the user's eyes are exposed to a laser beam, vision problems may result. Moreover, when the user's eyes are exposed to a laser beam for a long time, the user is likely to lose her/his eyesight. Therefore, a related art laser projectors are lacking in safety.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a laser projector of controlling power to drive a plurality of light sources according to a result of sensing conditions of the laser projector, which prevents a user from being exposed to a laser beam, and a method thereof.

In accordance with an aspect of the present invention, there is provided a laser projector which controls power to drive each of a plurality of light sources, the projector comprising: a plurality of light sources, a sensing unit, a power supply unit which supplies power to each of the light sources, and a control unit which controls the power supplied to the light sources according to a sensing result of the sensing unit.

The sensing unit may include a motion sensing sensor which senses, in a direction in which the laser projector emits light, whether there is a motion of an object.

When a motion of an object is sensed by the motion sensing sensor, the control unit may control the power supply unit to sequentially turn off the power supplied to each of the light sources.

When the motion of the object is sensed by the motion sensing sensor, the control unit may control the power supply unit to decrease the power supplied to each of the light sources.

When the motion of the object is sensed by the motion sensing sensor, the control unit may control the power supply unit to simultaneously turn off the power supplied to each of the light sources.

The sensing unit may include a tilt sensor which is configured to sense a slope of the laser projector.

When a slope sensed by the tilt sensor is in excess of a predetermined slope, the control unit may control the power supply unit to sequentially turn of the power supplied to the light sources.

When the slope sensed by the tilt sensor is in excess of the predetermined slope, the control unit may control the power supply unit to decrease the power supplied to each of the light sources.

When the slope sensed by the tilt sensor is in excess of the predetermined slope, the control unit may control the power supply unit to simultaneously turn off the power supplied to each of the light sources.

The laser projector may further comprise: a storage unit which stores a message; and an output unit; and the control unit may control the output unit to read and output the message, according to the sensing result of the sensing unit.

The message may be at least one of an animation message, a test message, and a voice message.

The output unit may include at least one of a speaker and a display panel.

In accordance with another aspect of the present invention, there is provided a method of controlling power of a laser projector including light sources, the method comprising: sensing conditions of the laser projector; and controlling the power supplied to each of the light sources according to the sensing result.

The sensing may comprise sensing, in a direction in which the laser projector emits light, whether there is a motion of an object.

When the motion of the object is sensed by the motion sensing sensor, the controlling may comprise sequentially turning off the power supplied to the light sources.

When the motion of the object is sensed by the motion sensing sensor, the controlling may comprise decreasing the power supplied to each of the light sources.

When the motion of the object is sensed by the motion sensing sensor, the controlling may comprise simultaneously turning off the power supplied to each of the light sources.

The sensing may comprise sensing a slope of the laser projector by using a tilt sensor.

When the slope sensed by the tilt sensor is in excess of a predetermined slope, the controlling may comprise sequentially turning off the power supplied to the light sources.

When the slope sensed by the tilt sensor is in excess of the predetermined slope, the controlling may comprise decreasing the power supplied to each of the light sources.

When the slope sensed by the tilt sensor is in excess of the predetermined slope, the controlling may comprise simultaneously turning off the power supplied to each of the light sources.

The method may further comprise controlling may comprise reading a pre-stored message according to the sensing result of the sensing unit and outputting the message through an output unit.

The pre-stored message may be at least one of an animation message, a test message, and a voice message.

The output unit may include at least one of a speaker and a display panel.

### BRIEF DESCRIPTION OF THE DRAWINGS

The above and/or other aspects of the present invention will be more apparent from the following detailed description of certain exemplary embodiments of the present invention with reference to the accompanying drawings, in which:

FIG. 1 is a block diagram of a laser projector according to an exemplary embodiment of the present invention;

FIG. 2 is a block diagram of a laser projector according to another exemplary embodiment of the present invention;

FIGS. 3A through 3C show message output screens according to various exemplary embodiments of the present invention;

FIG. 4 is a flow chart for explaining a method of controlling power of a laser projector according to an exemplary embodiment of the present invention;

FIG. 5 is a flow chart for explaining a method of controlling power of a laser projector according to another exemplary embodiment of the present invention; and

FIG. 6 is a flow chart for explaining a method of controlling power of a laser projector according to another exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

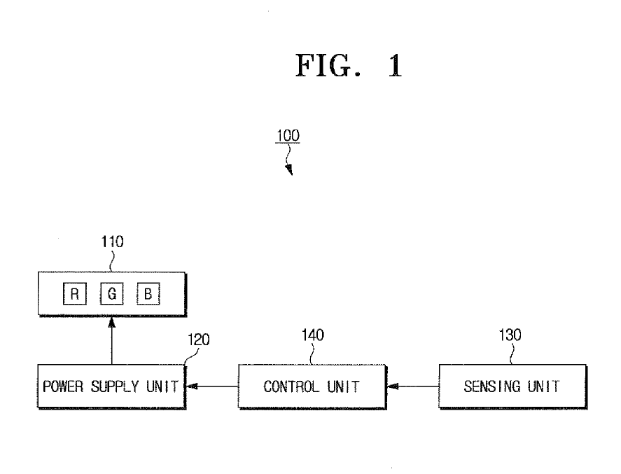

FIG. 1 is a block diagram of the constitution of a laser projector 100 according to an exemplary embodiment of the present invention. In FIG. 1, the laser projector 100 comprises: a light source unit 110, a power supply unit 120, a sensing unit 130 and a control unit 140.

The light source unit 110 includes a plurality of laser light sources, such as R (red), G (green) and B (blue) laser diodes. In this case, the light source unit 110 may include a plurality of R laser diodes, a plurality of G laser diodes, and a plurality of B laser diodes.

The power supply unit 120 supplies power to the light source unit 110. The power supply unit 120 may be individually connected to each of the R, G and B laser diodes and may supply power to each laser diode.

The sensing unit 130 senses conditions of the laser projector 100. The sensed conditions include a condition of a positioning of the laser projector 100. That is, the sensing unit 130 can sense whether a user is being exposed to a laser beam. Specifically, the sensing unit 130 can sense at least one of a motion of an object and a slope of a body of the laser projector 100, to sense a possibility that a user is exposed to the laser beam.

The control unit 140 controls the power supply unit 120 to control the power supplied to the light source unit 110, according to the sensing result of the sensing unit 130. Specifically, when the motion of the object is sensed by the sensing unit 130 or the slope of the body is in excess of a predetermined slope (for example, approximately 15°), the control unit 140 controls the power supply unit 120 to sequentially turn off the power supplied to the R, G and B laser diodes.

When the motion of the object is sensed by the sensing unit 130 or the slope of the body is in excess of a predetermined slope, the control unit 140 controls the power supply unit 120 to decrease the extent of the power supplied to the R, G and B laser diodes.

When the motion of an object is sensed by the sensing unit 130 or the slope of the body is in excess of the predetermined slope, the control unit 140 controls the power supply unit 120 to simultaneously turn off the power supplied to the R, G and B laser diodes. Accordingly, a user is prevented from being exposed to the laser beam.

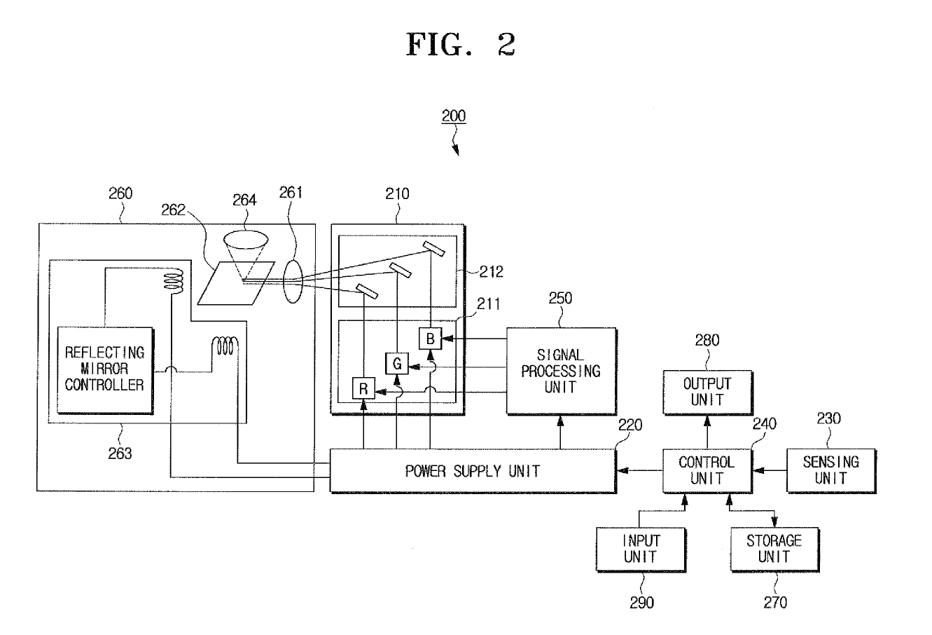

FIG. 2 is a block diagram of the constitution of a laser projector 200 according to another exemplary embodiment of the present invention. In FIG. 2, the laser projector 200 comprises: a light source unit 210, a power supply unit 220, a sensing unit 230, a control unit 240, a signal processing unit 250, an optic unit 260, a storage unit 270, an output unit 280, and an input unit 290.

The signal processing unit 250 processes an image signal.

The light source unit 210 includes a plurality of laser light sources 211 and a reflection unit 212. Specifically, the plurality of laser light sources 211, that is, R, G and B laser diodes, emit a light according to the image signal processed in the signal processing unit 250, to emit a laser beam. The reflection unit 212 reflects the laser beam emitted from the R, G and B laser diodes and transfers the laser beam to the optic unit 260.

The optic unit 260 processes the laser beam transferred from the light source unit 210 and emits the laser beam to the outside. In this case, the optic unit 260 includes a collimating lens 261, a reflecting mirror 262, a reflecting mirror controller 263, and a projecting lens 264.

The collimating lens 261 concentrates the laser beam transferred from the light source unit 210 and transfers the laser beam to the reflecting mirror 262.

The reflecting mirror 262 reflects the laser beam. In this case, the reflecting mirror 262 adjusts a reflection direction of the laser beam, according to an induced electromotive force generated in a coil of the reflecting mirror controller 263. The projecting lens 264 enlarges and transmits the laser beam reflected through the reflecting mirror 262 onto a screen, to display the image signal.

The power supply unit 220 supplies power to the light source unit 210, the signal processing unit 250 and the optic unit 260. The power supply unit 220 individually supplies power to each of the R, G and B laser diodes of the light source unit 210.

The sensing unit 230 senses conditions of the laser projector 200 and may comprise a motion sensing sensor. The motion sensing sensor may be realized as a light emitting device or a light receiving device as an optical sensor. In this case, the motion sensing sensor may be mounted on a surface of the body from which the laser beam is emitted to sense a motion of the object, specifically, a motion of the user.

The storage unit 270 stores a message. In this case, the message may be a warning message to notify the user that the user is exposed to the laser beam. This message may be stored as one or more of an animation message, a text message and a voice message.

The output unit 280 outputs the message. In this case, since the output unit 280 includes a speaker or a display panel, it is capable of outputting various kinds of messages.

The input unit 290 receives an input of a user instruction.

The control unit 240 controls the whole operation of the laser projector 200. According to the embodiment of the present invention where the sensing unit 230 is a motion sensing sensor, the control unit 240 maintains a turn-on state of the power supply unit 220 to supply the power to the light source unit 210, the signal processing unit 250 and the optic unit 260 when the laser projector 200 is driven. When the laser projector 200 is normally driven, the control unit 240 controls the power supply unit 220 to supply a voltage of 5V and a current of 3.0 A to the light source unit 210.

When the motion of an object is sensed by the sensing unit 230, that is, the motion sensing sensor, the control unit 240 controls the power supply unit 220 to sequentially turn off the power supplied to the R, G and B laser diodes of the light source unit 210. Specifically, when a signal of sensing a motion of an object is transferred from the sensing unit 230, the control unit 240 can control the power supply unit 220 and first turns off the power supplied to the G laser diode of the light source unit 210 and then turns off the power supplied to the R laser diode. That is, the power supplied to the G laser diode in which the extent of light energy emitted from the laser diode is great is turned off. Accordingly, when the laser beam emitted from the G laser diode is blocked, it is difficult to display a normal image based on the R and B laser diodes. Therefore, the user can perceive that there is a risk of being exposed to the laser beam at present, based on the change of the image display condition caused by the blocking of the laser beam of the G laser diode.

According to an alternate exemplary aspect of this embodiment, when the motion of an object is sensed by the sensing unit 230, the control unit 240 controls the power supply unit 220 to decrease the extent of the power supplied to the R, G and B laser diodes of the light source unit 210. Specifically, when the signal of sensing a motion of an object is transferred from the sensing unit 230, the control unit 240 controls the power supply unit 220 to supply the voltage of 5V and the current of 2.0 A to each of the R, G and B laser diodes included in the light source unit 210, to decreases the power. Or, the control unit 240 may decrease the power by supplying the voltage of 5V and the current of 1.0 A to each of the R, G and B laser diodes. In this case, as the power is decreasingly supplied, the extent of the energy of the laser beam emitted from the R, G and B laser diodes is decreased and therefore the user is prevented from being greatly affected even though the user is exposed to the laser beam.

According to another exemplary aspect of this embodiment, when the signal of sensing the motion of the object is transferred by the sensing unit 230, the control unit 240 controls the power supply unit 220 to simultaneously turn off the power supplied to the R, G and B laser diodes of the light source unit 210. Accordingly, the laser beam is prevented from exposing to the user and therefore the safety for the user is maximized.

According to another exemplary aspect of this embodiment, when the signal of sensing a motion of an object is transferred from the sensing unit 230, the control unit 240 controls the output unit 280 to read the message stored in the storage unit 270 and to output the message in the form of one or more of a text, an animation and a voice. Specifically, a message which is output in the form of text and/or animation is output through the display panel of the output unit 280. Further, a message which is output in the form of a voice is output through a speaker of the output unit 280. Accordingly, the user is able to understand that there is a risk of being exposed to the laser beam at present.

When a restoration instruction is input from the input unit 290 while the power supply of the power supply unit 220 is controlled as a motion of an object is sensed by the sensing unit 230, the control unit 240 controls the power supply unit 220 to supply the power the R, G and B laser diodes of the light source unit 210.

When the motion of the object is not sensed through the sensing unit 230 while the power supply of the power supply unit 220 is controlled as the motion of the object is sensed by the sensing unit 230, the control unit 240 controls the power supply unit 220 to supply the power to the R, G and B laser diodes of the light source unit 210. Accordingly, the operation of the laser projector 200 can be manually restored based on the user's input. Further, the operation of the laser projector 200 can be automatically restored based on a sensing result of the sensing unit 230.

The sensing unit 230 may be a tilt sensor. The tilt sensor can sense a slope of the body of the laser projector 200, and it may be positioned in the middle of the body. Generally, when the user lifts the body of the laser projector 200, the user is likely to be exposed to the laser beam. Therefore, whether or not the user may be exposed to the laser beam can be sensed by sensing the slope of the body.

In accordance with the exemplary embodiment using the tilt sensor, when the slope sensed through the sensing unit 230 is in excess of a predetermined slop (for example, approximately 15°), the control unit 240 can first turn off the power supplied to the G laser diode of the light source unit 210 and then turn off the power supplied to the R laser diode. Subsequently the control unit 240 finally turns off the power supplied to the B laser diode. That is, the power supplied to the G laser diode, in which the extent of the light energy emitted from the laser diodes is great, is turned off.

According to another exemplary aspect of this embodiment, when the slope sensed through the sensing unit 230 is in excess of the predetermined slope (for example, approximately 15°), the control unit 240 controls the power supply 220 to supply a voltage of 5V and a current of 2.0 A to each of the R, G and B laser diodes included in the light source unit 210. As the power which is lower than the power supplied when the laser projector 200 is normally operated (with a voltage of 5V and a current of 3.0 A), the extent of the energy of the laser beam emitted from the R, G and B laser diodes is decreased and therefore, the user is prevented from being greatly affected even though the user is exposed to the laser beam.

According to another exemplary aspect of this embodiment, when the slope sensed through the sensing unit 230 is in excess of the predetermined slope (for example, approximately 15°), the control unit 240 controls the power supply unit 220 to simultaneously turn off the power supplied to the R, G and B laser diodes of the light source unit 210. Accordingly, the laser beam is prevented from exposing the user and therefore the safety for the user is maximized.

According to another exemplary aspect of this embodiment, when the slope sensed through the sensing unit 230 is in excess of the predetermined slope (for example, approximately 15°), the control unit 240 controls the output unit 280 to read the message stored in the storage unit 270 and to output the message in the form of one or more of an animation, text and voice.

When a restoration instruction is input through the input unit 290 while the power supply of the power supply unit 220 is being controlled depending on the slope sensed through the sensing unit 230, the control unit 240 controls the power supply unit 220 to supply the power the R, G and B laser diodes of the light source unit 210.

When a slope of 0° to 15° is sensed through the sensing unit 230 while the power supply of the power supply unit 220 is controlled depending on the slope sensed through the sensing unit 230, the control unit 240 controls the power supply unit 210 to supply the normal power to the R, G and B laser diodes of the light source unit 210. Accordingly, the operation of the laser projector 200 can be manually or automatically restored.

For the description of FIG. 2, the sensing unit 230 includes, for example, an optical sensor or a tilt sensor. However, the sensing unit 230 may include both an optical sensor and a tilt sensor. In this case, the above-described operation can be performed if one or more of a motion of an object and a slope more than the predetermined angle is sensed. Additionally, instead of using a tilt sensor, a position change of the body of the laser projector may be sensed by using a mechanical switch. That is, the mechanical switch may be manufactured to protrude from a lower surface of the laser projector 200. When the lower surface of the laser projector is in contact with a support surface, the mechanical switch is turned on, and when the lower surface is separated from the support surface, the mechanical switch is turned off. When the mechanical switch is turned off because the lower surface of the laser projector 200 is separated from the support surface, the power supplied to the plurality of the laser light sources can be individually controlled.

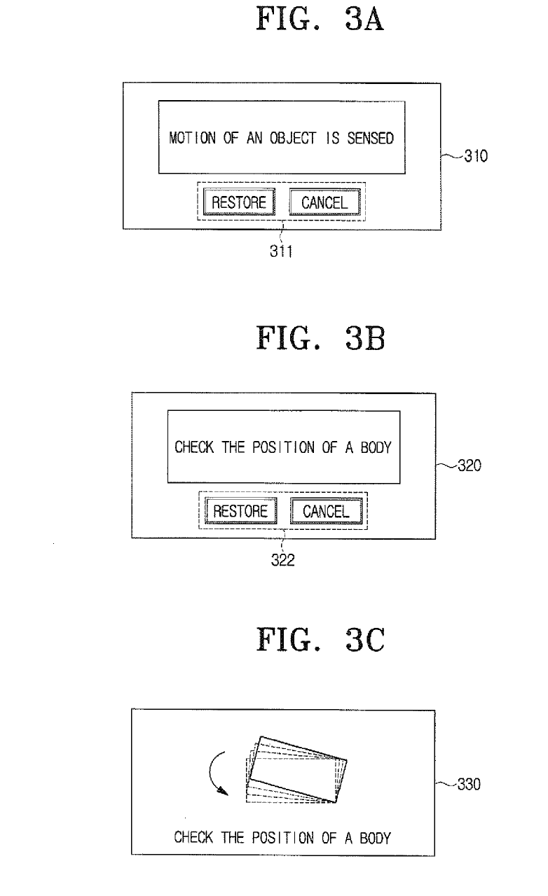

FIGS. 3A through 3C show message output screens according to various exemplary embodiments of the present invention. FIG. 3A shows a message output screen when a motion of an object is sensed. In FIG. 3A, when a motion of an object (for example, the motion of the user) is sensed through the optical sensor while the laser projector 200 is normally driven, the laser projector 200 outputs a first message 310 through the display panel. In this case, the first message 310 is output in the form of a text reading “Motion of an object is sensed” as shown in FIG. 3A, to inform the user that the laser projector is not normally operated due to the motion of the object at present.

When the user selects ‘restore’ of a selection region 311 after checking the first message 310, the laser projector 200 supplies the power to each of the R, G and B laser diodes, to be normally operated.

FIG. 3B shows a message output screen when a slope in excess of the predetermined slope is sensed. When the slope of the body is sensed as being in excess of 15° through the tilt sensor, while the laser projector 200 is normally driven, the laser projector 200 outputs a second message 320 through the display panel. In this case, the second message 320 is output in the form of a text reading “Check the position of the body” as shown in FIG. 3B, to inform the user that the laser projector 200 is not normally operated due to the present position of the body. When the user selects ‘restore’ of a selection region 322 after checking the second message 320, the laser projector 200 supplies the power to each of the R, G and B laser diodes, to be normally operated.

FIG. 3C shows a message output screen according to another embodiment when a slope in excess of the predetermined slope is sensed. When the slope of the body is sensed as being in excess of 15° through the tilt sensor while the laser projector 200 is normally driven, the laser projector 200 outputs a third message 330 through the display panel. In this case, the third message 330 is output in the form of an animation showing that the position of the body is tilted and in the form of the text reading “Check the position of the body” as shown in FIG. 3C, to more clearly inform the user of the present position state of the body of the laser projector 200.

When any of the first, second and third messages 310, 320 and 330 as shown in FIGS. 3A through 3C are output, a warning sound or a voice message may be output simultaneously through the speaker, so that a user more easily understands the operating condition of the laser projector 200.

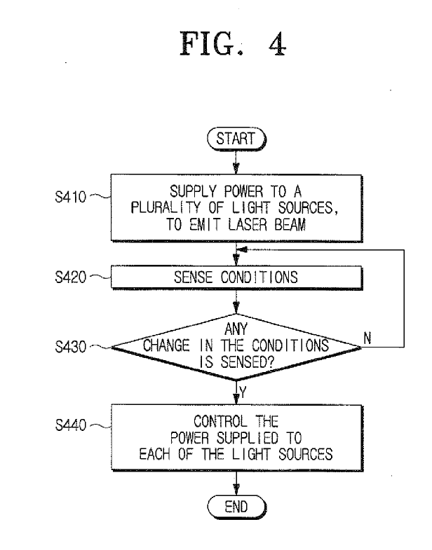

FIG. 4 is a flow chart for explaining a method of controlling the power of a laser projector 100 according to an exemplary embodiment of the present invention. In FIG. 4, the laser projector 100 supplies power to a plurality of laser light sources and it emits a laser beam (S410). In this case, the plurality of laser light sources may be R, G and B laser diodes, and power may be individually supplied to each of the laser light sources.

Subsequently, the laser projector 100 senses a change in condition(s) (S420). Specifically, the condition(s) may be a state in which the laser projector 100 is positioned. That is, whether the laser projector 100 is in a state of exposing a user to a laser beam is sensed. Specifically, whether a user is exposed to the laser beam is sensed by sensing one of more of a motion of an object, in particular, a motion of a user, and a slope of a body of the laser projector 100.

Subsequently, when a change in a condition is sensed (S430), the laser projector 100 individually controls the power supplied to the plurality of laser light sources (S440). Specifically, when a motion of an object is sensed or when the body of the laser projector 100 is sensed as having a slope more than a predetermined angle (for example, approximately 15°), the laser projector 100 individually controls the power supplied to each of the R, G and B laser diodes. Accordingly, the user is prevented from being exposed to the laser beam.

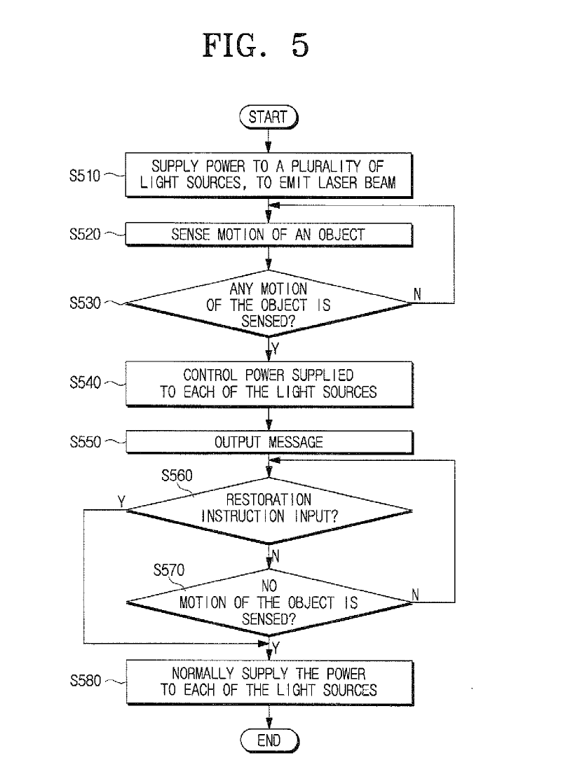

FIG. 5 is a flow chart for explaining a method of controlling power of a laser projector 200 according to another exemplary embodiment of the present invention. In FIG. 5, the laser projector 200 supplies power to a plurality of laser light sources and it emits a laser beam (S510).

Subsequently, the laser projector 200 senses a motion of an object (S520). In this case, the motion of the object may be sensed by using an optical sensor.

Subsequently, when the motion of the object is sensed (S530), the laser projector 200 individually controls the power supplied to each of the laser light sources (S540). Specifically, when the motion of the object is sensed, the power supplied to the G laser diode in which the energy of the laser beam is great is preferentially turned off. Subsequently the power supplied to the R laser diode is turned off and the power supplied to the B laser diode is turned off. That is, the power is turned off in the order of G, R and B laser diodes.

Alternately, when the motion of the object is sensed, the extent of the power supplied to the R, G and B laser diodes is decreased. Specifically, when the motion of the object is sensed while the laser projector 200 is normally operated and the voltage of 5V and the current of 3.0 A are supplied to the laser diodes, the power is decreased by supplying the voltage of 5V and the current of 2.0 A to the R, G and B laser diodes. Accordingly, since the energy extent of the laser beam emitted from the R, G and B laser diodes is decreased, the user is prevented from being greatly affected even though the user is exposed to the laser beam.

Alternately, when the motion of the object is sensed, the power supplied to the R, G and B laser diodes is turned off simultaneously. Accordingly, the laser beam is prevented from exposing to the user and therefore the safety for the user is maximized

Subsequently, the laser projector 200 outputs a message (S550). Specifically, a message to inform the user that a motion of an object is sensed may be output in the form of one or more of an animation, text and voice. Animation and text messages can be output through a display panel and a voice message can be output through a speaker.

When a restoration instruction is input (S560) or no motion of the object is sensed (S570) while the power supplied to the plurality of laser light sources is controlled, the laser projector 200 normally supplies the power to each of the laser light sources (S580). Accordingly, the operation of the laser projector 200 is manually or automatically restored to be normally operated.

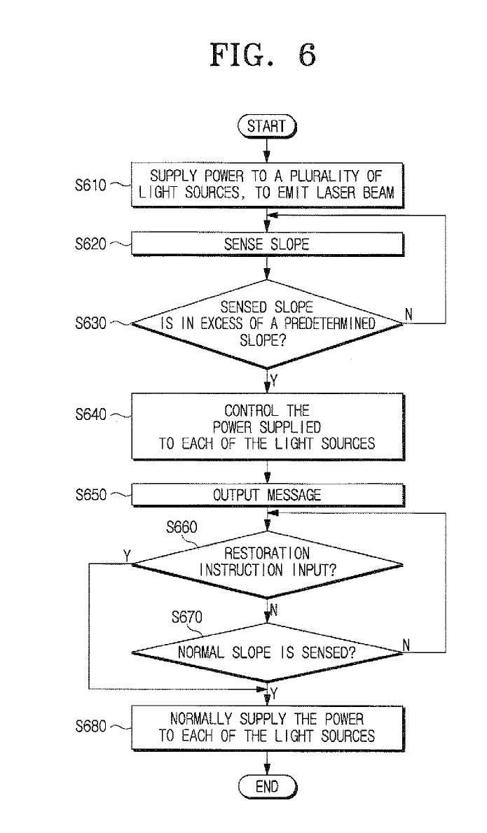

FIG. 6 is a flow chart for explaining a method of controlling power of a laser projector 200 according to another exemplary embodiment of the present invention. In FIG. 6, the laser projector 200 supplies power to a plurality of laser light sources, and it emits a laser beam (S610).

Subsequently, the laser projector 200 senses a slope of a body S620. In this case, the slope may be sensed by using a tilt sensor.

Subsequently, when the sensed slope is in excess of a predetermined slop (for example, approximately 15°) (S630), the laser projector 200 individually controls the power supplied to each of the laser light sources (S640). Specifically, when the sensed slope is in excess of the predetermined slope (for example, approximately 15°), the power is turned of in the order of G, R and B laser diodes, thereby sequentially turning off the power supplied to the laser light sources.

Alternately, when the sensed slope is in excess of the predetermined slop (for example, approximately 15°), the extent of the power supplied to the R, G and B laser diodes is decreased. Specifically, when the slope in excess of 15° is sensed while the laser projector 200 is normally operated and the voltage of 5V and the current of 3.0 A are supplied to the laser diodes, the power is decreased by supplying the voltage of 5V and the current of 2.0 A to the R, G and B laser diodes.

Alternately, when the sensed slope is in excess of a predetermined slop (for example, approximately 15°), the power supplied to the R, G and B laser diodes is turned off simultaneously.

Subsequently, the laser projector 200 outputs a message (S650). Specifically, a message to inform the user that the position of the body is changed may be output in the forms of one or more of an animation, text and voice.

When a restoration instruction is input (S660) or a normal slope (within the range of 0° to 15°) is sensed (S670) while the power supplied to the plurality of laser light sources is controlled, the laser projector 200 normally supplies the power to each of the laser light sources (S680). Accordingly, the operation of the laser projector 200 is manually or automatically restored to be normally operated.

As described above, in accordance with the present invention, at least one of a motion of an object and a slope is sensed. When a motion of an object is sensed or the sensed slope of the body is in excess of a predetermined slope, the power supplied to the laser light sources is controlled. Accordingly, the laser beam is prevented from exposing the user, and safer use of the laser projector is realized.

The foregoing exemplary embodiments and advantages are merely exemplary and are not to be construed as limiting the present invention. The present teachings can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A laser projector comprising:
a plurality of light sources;
a sensing unit;
a power supply unit which supplies power to each of the light sources; and
a control unit which adjusts the power supplied to the light sources, based on a sensing result of the sensing unit.

2. The laser projector as claimed in claim 1, wherein the sensing unit comprises a motion sensing sensor which senses, whether there is motion of an object in a direction in which the laser projector emits light.

3. The laser projector as claimed in claim 2, wherein, if the motion of the object is sensed by the motion sensing sensor, the control unit controls the power supply unit to sequentially turn off the power supplied to the light sources.

4. The laser projector as claimed in claim 2, wherein, if the motion of the object is sensed by the motion sensing sensor, the control unit controls the power supply unit to decrease the power supplied to each of the light sources.

5. The laser projector as claimed in claim 2, wherein, if the motion of the object is sensed by the motion sensing sensor, the control unit controls the power supply unit to simultaneously turn off the power supplied to each of the light sources.

6. The laser projector as claimed in claim 1, wherein the sensing unit comprises a tilt sensor which senses a slope of the laser projector.

7. The laser projector as claimed in claim 6, wherein, if the slope sensed by the tilt sensor is in excess of a predetermined slope, the control unit controls the power supply unit to sequentially turn off the power supplied to the light sources.

8. The laser projector as claimed in claim 6, wherein, if the slope sensed by the tilt sensor is in excess of the predetermined slope, the control unit controls the power supply unit to decrease the extent of the power supplied to each of the light sources.

9. The laser projector as claimed in claim 6, wherein, if the slope sensed by the tilt sensor is in excess of the predetermined slope, the control unit controls the power supply unit to simultaneously turn off the power supplied to each of the light sources.

10. The laser projector as claimed in claim 1, further comprising:
a storage unit which stores a message; and
an output unit which outputs the message, and
wherein the control unit controls the output unit to output the message stored in the storage unit, based on the sensing result of the sensing unit.

11. The laser projector as claimed in claim 10, wherein the message is at least one of an animation message, a text message and a voice message.

12. The laser projector as claimed in claim 10, wherein the output unit comprises at least one of a speaker and a display panel.

13. A method of controlling power of a laser projector including a plurality of light sources, the method comprising:
sensing a condition of the laser projector; and
adjusting the power supplied to the light sources, based on a result of the sensing.

14. The method as claimed in claim 13, wherein the sensing comprises sensing whether there is motion of an object in a direction in which the laser projector emits light.

15. The method as claimed in claim 14, wherein the adjusting comprises, if a motion of an object is sensed, sequentially turning off the power supplied to the light sources.

16. The method as claimed in claim 14, wherein the adjusting comprises, if a motion of an object is sensed, decreasing the power supplied to each of the light sources.

17. The method as claimed in claim 14, wherein the adjusting comprises, if a motion of an object is sensed, simultaneously turning off the power to each of the light sources.

18. The method as claimed in claim 13, wherein the sensing comprises sensing a tilt of the laser projector.

19. The method as claimed in claim 18, wherein the adjusting comprises, if a slope sensed is in excess of a predetermined slope, sequentially turning off the power supplied to the light sources.

20. The method as claimed in claim 18, wherein the adjusting comprises, if a slope sensed is in excess of a predetermined slope, decreasing the power supplied to each of the light sources.

21. The method as claimed in claim 18, wherein the adjusting comprises, if a slope sensed is in excess of a predetermined slope, simultaneously turning off the power supplied to each of the light sources.

22. The method as claimed in claim 13, further comprising outputting a pre-stored message through an output unit, based on the result of the sensing.

23. The method as claimed in claim 22, wherein the pre-stored message is at least one of an animation message, a text message and a voice message.

24. The method as claimed in claim 22, wherein the output unit comprises at least one of a speaker and a display panel.
